(19) United States
(12) Patent Application Publication
(10) Pub. No.: US 2006/0223639 A1
(43) Pub. Date: Oct. 5, 2006

(54) Game chip

(75) Inventors: Toshimi Koyama, Tokyo (JP); Nobuyuki Nonaka, Tokyo (JP); Jituo Migita, Kami-gun (JP)

Correspondence Address: LEYDIG VOIT & MAYER, LTD, 700 THIRTEENTH ST. NW, SUITE 300, WASHINGTON, DC, 20005-3960, US

(73) Assignees: Aruze Corp., Tokyo (JP); Seta Corp., Tokyo (JP); MINERVA Corp., Kami-gun (JP)

(21) Appl. No.: 11/300,598

(22) Filed: Dec. 15, 2005

(30) Foreign Application Priority Data
Dec. 20, 2004 (JP) 2004-367239

(51) Int. Cl. G06F 19/00

(52) U.S. Cl. 463/47

(57) ABSTRACT

The present invention relates to the technology of recognizing and reading each game chip although game chips are stacked. The present invention is a game chip storing data readable by a reader/writer having an antenna which emits an electromagnetic wave and available in a stack of game chips, and includes: an IC device for communicating data at a request from the reader/writer; an antenna electrode connected to the IC device, and configured such that the antenna electrode can enter a resonant state with an antenna of the reader/writer through an electromagnetic wave; and a reflection member for reflecting an electromagnetic wave reflected from the antenna of the reader/writer toward upper game chips in the stack.

The present disclosure relates to subject matters contained in Japanese Patent Application No. 2004-367239 filed on Dec. 20, 2004, which are expressly incorporated herein by reference in its entireties.

### BACKGROUND OF THE INVENTION

1. Field of the Invention

The present invention relates to a game chip, and more specifically to a game chip enabling data to be read by a read device such as an IC card reader/writer, etc.

2. Description of the Prior Art

Conventionally, among games familiar to a large number of people, there are games in which a player determines how much he or she bets by placing game chips at an optional position on a game table. A game of this type can be, for example, roulette, card games such as poker, blackjack, etc.

As various amusement facilities have become widespread, equipment that allows a gaming machine arranged in an amusement place such as a game arcade and a casino, etc. to provide a player with more realistic and true-to-life feeling has been introduced, and a number of gaming machines of above-mentioned types have become popular in the market.

Some gaming machines of above-mentioned types request a player to input a target of a bet and the number of chips for the bet by pressing a button through a so-called control panel. These gaming machines are not accompanied by an operation of a player placing game chips, thereby lacking the realistic and real-to-life feeling in playing a game.

Accordingly, there is a proposed technology of embedding an IC chip and an IC tag in a game chip, reading the game chip containing the IC chip, etc. by a gaming machine using a reader/writer, and processing the read data as the input of a player. The technology is disclosed by, for example, Japanese Patent Laid-Open No. 2003-196634 (paragraph [0014]), Japanese Patent Laid-Open No. 2003-085504 (FIG. 1), Japanese Patent Laid-Open No. 2004-021648 (paragraph [0023], FIG. 7), etc.

### SUMMARY OF THE INVENTION

Generally, a player at a gaming machine can bet for a target (for example, a specific number, red/black, odd/even, etc.) with any number of game chips. The player makes a bet by laying game chips of the number corresponding to the amount of bet determined by the player in a predetermined area (for example, an area assigned to each of the numbers 1 to 36, an area assigned to each of red/black, odd/even, etc.) on the game table.

In this case, the game chips are to be laid in an area corresponding to the bet target. However, when the number of game chips for a bet is large, the game chips may not be laid within the assigned area. In this case, the game chips are stacked like a tower in the area for the bet target, thereby successfully laying the game chips within the desired area.

However, in a gaming machine operated in the technology of reading game chips using a reader/writer, when game chips are stacked high, the upper game chips are distant from the reader/writer, and an electromagnetic wave as a read signal emitted from the reader/writer is scattered and attenuated in proportion to the height of the stack of the game chips. As a result, it becomes difficult or unstable for the reader/writer to recognize and read the game chips. Especially, when wireless communications are performed using a highly linear high frequency band (for example, a UHF band), not only the game chips vertically above, but also the adjacent chips stacked by the scattered electromagnetic wave can be read.

The present invention aims at providing a game chip which can be correctly recognized and read without an erroneous read although the game chips are stacked or there are adjacent game chips stacked for a bet in a different position.

As means for solving the above-mentioned problems, the present invention has the following characteristics.

The first aspect of the present invention is proposed as a game chip available as stacked. The game chip stores data readable by a read device (for example, a reader/writer) having an antenna which emits an electromagnetic wave The “game chip” referred to in this specification is a tool for use in indicating a target of a bet and the value of a valuable account (cash, credit, point, etc.) when the player expresses the intention to bet, and the “game chip” in this specification includes coin, medal, etc.

The game chip according to the present aspect has circuit means (for example, a circuit, an IC chip, an IC device, etc.) for communicating data at a request from a read device, antenna means (for example, an antenna (electrode, etc.)) connected to the circuit means and configured such that a resonant state can be entered with an antenna of the read device through a electromagnetic wave, and reflection means (for example, a reflector, a reflection member, etc.) for reflecting the electromagnetic wave emitted by the antenna of the read device toward the upper surface of the stacked game chips.

Since the game chips according to the present invention has reflection means, the electromagnetic wave emitted from the read device is not transmitted or leaked from the inside to the outside of the game chip, but can be transmitted upward within the game chip. As a result, as compared with the case in which an electromagnetic wave is scattered in the air outside a conventional game chip, the game chip according to the present invention can receive an electromagnetic wave from the read device in a strong status.

Using the reflection means, a read signal generated by the read device does not unnecessarily leak to an external space, adjacent chip stacks do not interfere with each other, thereby correctly performing a data read processing by the read device.

With the game chip, the reflection means can be a member arranged at the perimeter of the game chip, and the reflection means of adjacent game chips can touch each other when the game chips are stacked.

With the above-mentioned configuration, since the reflection member is cylindrical and the adjacent cylindrical members touch each other, the electromagnetic wave for a read does not externally leak, but reaches the top game chip without reducing the electric field strength. As a result, although a larger number of game chips are stacked than in the conventional technology, the data of each game chip can be correctly read.

The game chip according to the present invention may have a further feature that the game chip has a body member housing the circuit means and the antenna means, and the reflection means is allocated at a peripheral portion of the body member.

The game chip according to the present invention may have a further feature that the circuit means is cylindrical, the antenna means is a pair of electrodes between which the circuit means is located, and the circuit means and the reflection means are arranged coaxially.

The game chip according to may have a further feature that the reflection means is a metallic foil or a plate made of at least one of iron, aluminum, and steel alloy.

The game chip according to the present invention may have a further feature that the game chip further comprises protection means which surrounds the reflection means.

The game chip according to the present invention may have a further feature that the reflection means and the protection means are substantially the same in thickness.

### BRIEF DESCRIPTION OF THE DRAWINGS

FIG. 1 is a perspective view of a gaming machine;

FIG. 2 is a functional block diagram of the gaming machine;

FIG. 3A is a perspective view of a game chip;

FIG. 3B is a sectional view along the line B-B in FIG. 3A;

FIG. 3C is a sectional view along the line C-C in FIG. 3B;

FIG. 4 shows an electromagnetic wave generated when a reader/writer reads a game chip; and

FIG. 5 shows an electromagnetic wave generated when a reader/writer reads a game chip.

The accompanying drawings, which are incorporated in and constitute a part of the specification, illustrate embodiments of the invention, and together with the general description given above and the detailed description of the embodiments given below, serve to explain the principles of the invention.

### DESCRIPTION OF THE PREFERRED EMBODIMENTS

The embodiments according to the present invention are described below in detail with reference to the drawings.

[1. Gaming Machine Processing Game Chips]

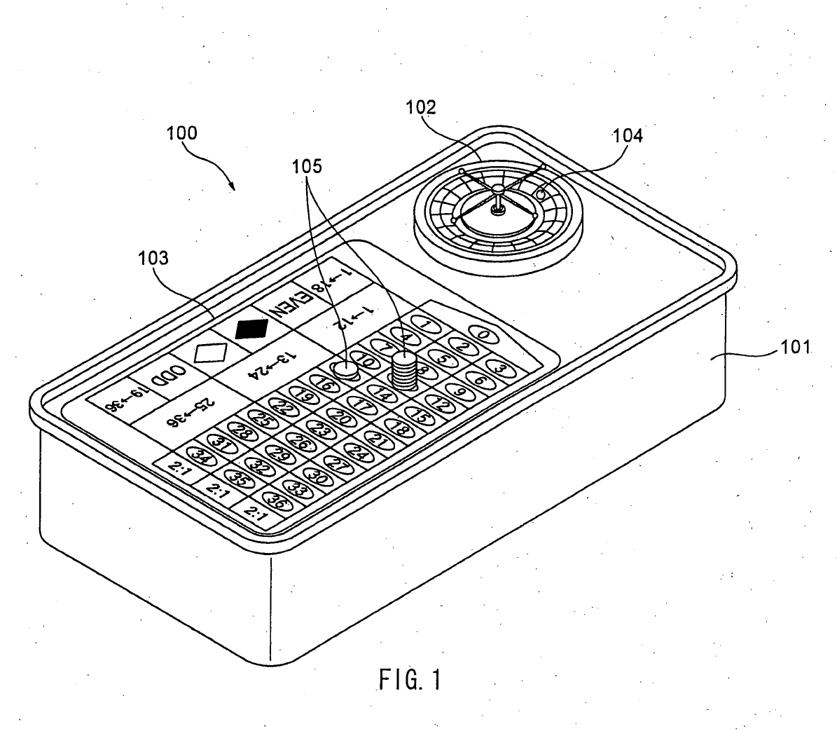

First, the gaming machine using the game chip according to the present embodiment is explained below. FIG. 1 is a perspective view of the gaming machine using the game chip according to the present embodiment.

A gaming machine 1 according to the present embodiment is a device for allowing a player to play roulette. As shown in FIG. 1, a gaming machine 100 has and a wheel 102 and a layout 103 at an upper surface of table-shaped gaming machine body 101. The wheel 102 has pockets respectively corresponding to the numbers of “0”, “00”, and “1” to “36”. The layout 103 has a plurality of bet areas (area for designation of a target of a bet) corresponding to the numbers of “0”, “00”, and “1” to “36”.

The player predicts which number of pocket a ball 104 thrown into a turning wheel 102 will enter, and lays a game chip 105 in any area in the layout 103 according to the prediction. By the operation of laying the game chip 105, the input of the bet in the gaming machine 100 is performed. If the prediction of the player comes true, the player can receive a dividend depending on the game chips laid for the bet.

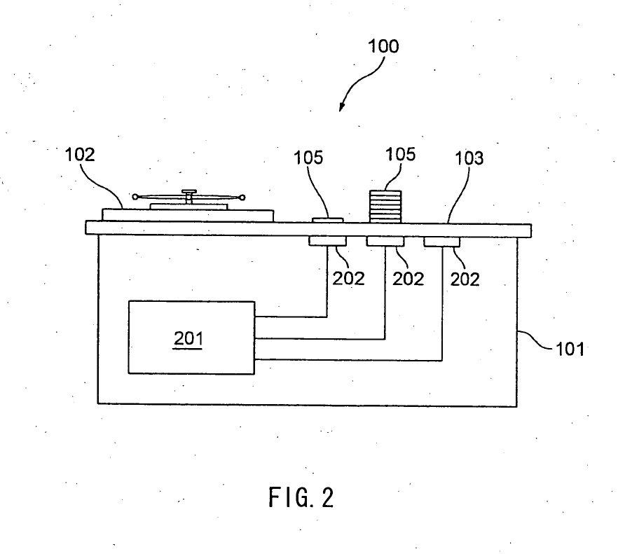

FIG. 2 is a functional block diagram showing the main internal configuration of the gaming machine 100. The gaming machine 100 includes a main control device 201 for control of the main operation of the gaming machine, and a plurality of readers/writers 202 provided under the layout 103 and corresponding to the respective bet areas.

The reader/writer 202 as a read device reads the information (ID information in the present embodiment) stored in the game chip 105 when the game chip 105 is laid in a bet area within its read range, and notifies the main control device 201 of the information. In this specification, it is referred to as a “reader/writer”, but it is not always necessary to have a writing function. That is, a device having the function of reading data stored in the game chip 105 can be used as a “reader/writer” in this specification.

The ID information stored in the game chip 105 is the information uniquely designating the game chip 105. According to the ID information, it is discriminated that the game chip 105 relates to what value of which player. The information stored in the game chip 105 is not always ID information designating the game chip 105, but can be any information discriminating that the game chip 105 indicates what value of which player. For example, player ID information and chip value information (for example, the information indicating the value of one coin, the value of ten coins, the value of 100 coins, etc.) can be stored together in the game chip 105.

The main control device 201 recognizes which player makes a bet in which bet area by receiving read information from each reader/writer 202. The main control device 201 detects using a sensor (not shown in the attached drawings) provided in the wheel 102 about in which pocket the ball stops, determines the winning/losing status of each player and the dividend according to the information transmitted from the reader/writer 202 about which player makes a bet with how many chips laid in which bet area, and performs a game process such as adding a dividend to the credit of the player on the separately provided display device (not shown in the attached drawings) showing the payout.

[2. Example of Configuration of Game Chip]

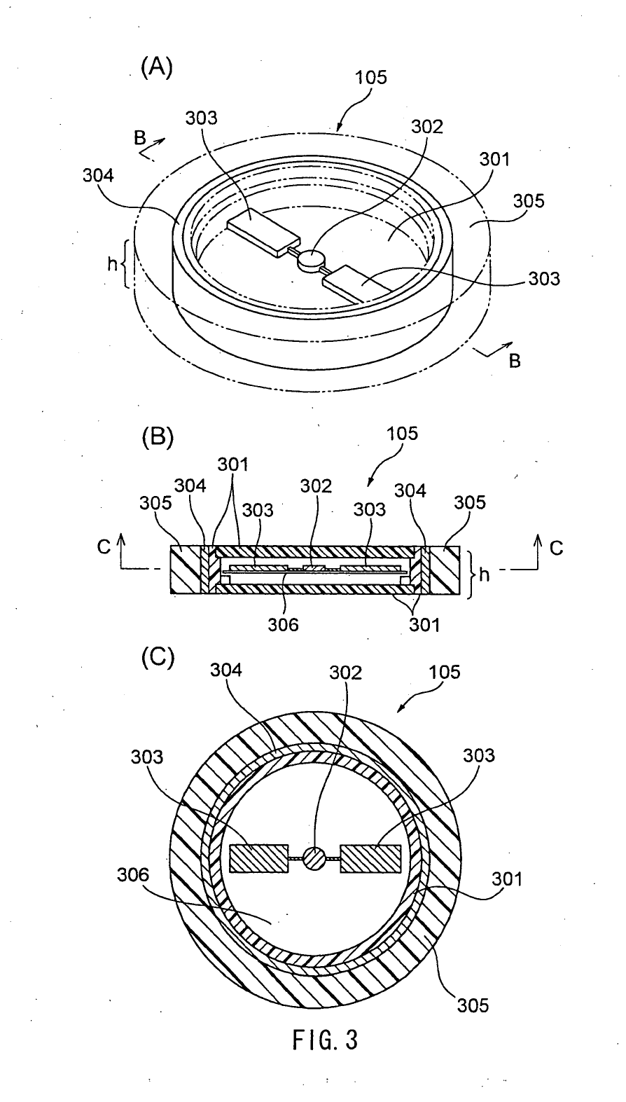

The example of the configuration of the game chip 105 according to the present embodiment is explained below by referring to FIGS. 3A to 3C. FIG. 3A is a perspective view of the game chip 105. FIG. 3B is a sectional view along the sectional line B-B shown in FIG. 3A. FIG. 3C is a sectional view along the sectional line C-C shown in FIG. 3B.

As shown in FIGS. 3A to 3C, the game chip 105 stores a substrate 306 in a body 301 formed by a resin, etc. The substrate 306 is loaded with an IC device 302 as circuit means, and an antenna electrode 303 as antenna means connected to the IC device 302. A reflection member 304 is a cylindrical member, and fitted to the body 301 so as to surround an outer peripheral surface of the body 301. The body 301 and reflection member 304 are formed by a material having the characteristic of reflecting an electromagnetic wave emitted by the reader/writer. A protection ring 305 is a cylindrical member for protecting the body 301 and the reflection member 304 outside the reflection member 304.

The reflection member 304 is provided outside the antenna electrode 303, but it is not limited to the outside of the body 301.

The IC device 302 is an electronic part designed to perform a processing function, a storage function, and an input/output control function, and has the function of passing stored information to the reader/writer 202 at a request from the reader/writer 202.

The antenna electrode 303 performs communication of a signal between the reader/writer 202 and the game chip 105, converts a carrier wave from the reader/writer 202 to electric power, and provides the power for the IC device 302.

The reflection member 304 is a cylindrical member arranged around the peripheral surface of the game chip 105, and it is preferable that the height h of the reflection member 304 is subsequently equal to the thickness of the game chip 105. When a plurality of game chips 105 are stacked, reflection members 304 of the adjacent game chips 105 can contact each other.

The reflection member 304 can be formed any material having the characteristic of reflecting an electromagnetic wave emitted by the reader/writer 202. For example, it can be a film or a plate of metal such as copper, aluminum, steel, etc.

The form and the arrangement position of the reflection member 304 are not limited to the applications shown in FIGS. 3A to 3C. It can be of any shape other than a cylindrical shape so far as the game chips 105 can contact the reflection member 304 of the adjacent game chips 105 when the chips are stacked. The reflection member 304 is not always to be plate-shaped, but can be a mesh- or grating-shaped member wound around the perimeter of the body 301.

[3. Example of Operation of Game Chip]

Explained below is an example of the operation of the game chip 105.

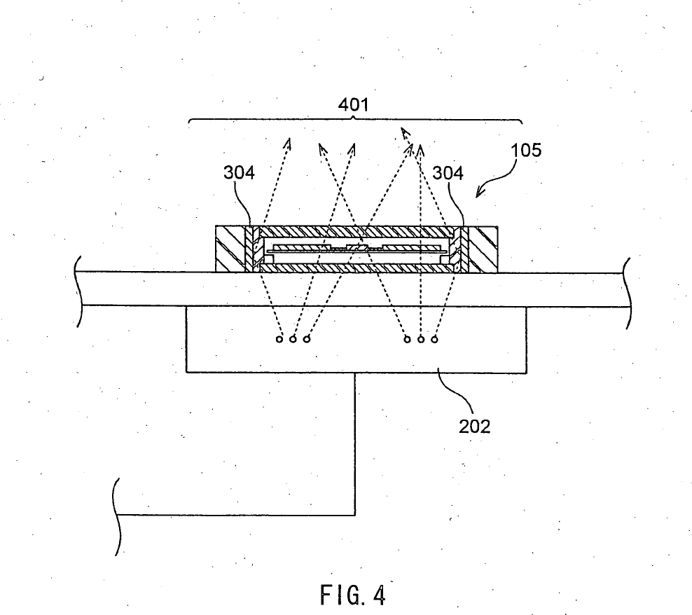

FIG. 4 shows the state of the electromagnetic wave generated when the reader/writer 202 reads the game chip 105 placed on the layout 103.

The reader/writer 202 generates a high frequency (for example, 880 MHz to 2.45 GHz) for a read, and emits it as an electromagnetic wave from an antenna (electrode). The transmitted electric wave is received by the antenna electrode 303 of the game chip 105, and provides power for an IC chip for a game.

The game chip 105 receives the transmitted electric wave, the antenna electrode 303 of the game chip 105 enters the resonant state with the reader/writer 202, and means for switching the load resistance in the game chip 105 can detect data transmitted from the game chip 105 on the reader/writer 202 side.

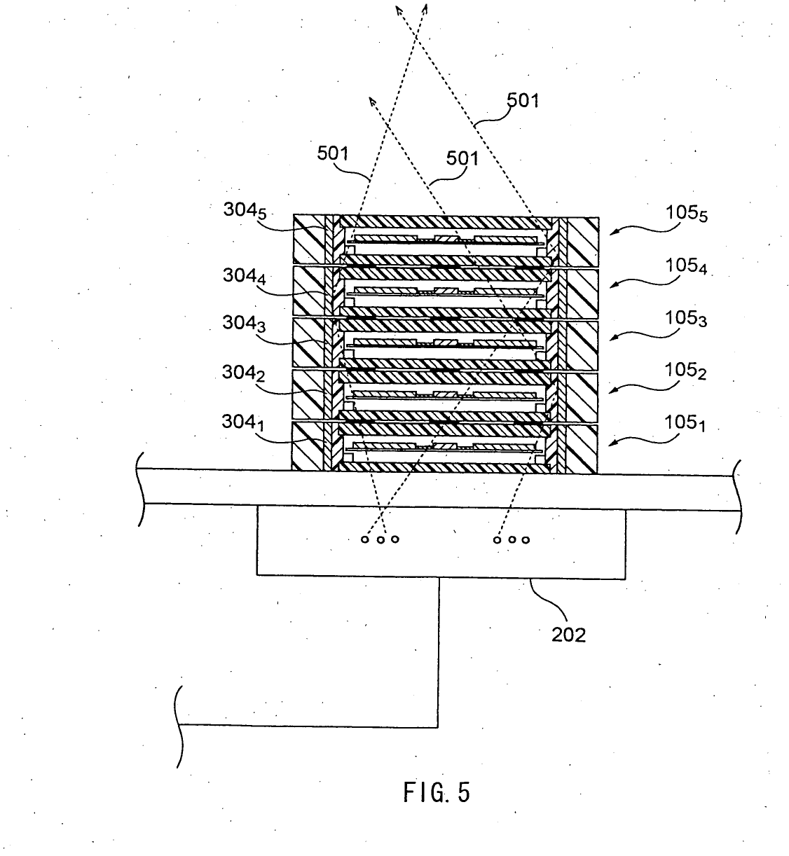

The status of the electromagnetic wave when the reader/writer 202 reads the game chip 105 placed on the layout 103 with a plurality of game chips 105 stacked is explained by referring to FIG. 5. FIG. 5 shows an example of the status of the electromagnetic wave when the game chip 105 is read with the chips stacked.

In the example shown in FIG. 5, the stack of five game chips 105₁ to 105₅ is read by the reader/writer 202.

An electromagnetic wave 501 is emitted from the reader/writer 202 into the game chips 105₁ to 105₅, reflected by a cylindrical inner wall configured by the reflection members 304₁ to 304₅ of each of the game chips 105₁ to 105₅, and can reach the game chip 105₅ positioned at the top without leaking outside the game chips 105₁ to 105₅.

With the conventional game chip, the electromagnetic wave reflected by the cylindrical inner wall configured by reflection members 304₁ to 304₅ is lost without reaching the upper game chips. However, with the game chip 105 according to the present embodiment, upper game chip 105 in a stack can be effectively read using the electromagnetic wave which has been lost in the conventional technology. Thus, a higher stack of game chips can be read.

The present invention has been explained as a game chip applied to a gaming machine, but the present invention is not limited to a game chip, and can be applied to all devices in a noncontact communication system using electromagnetic coupling such as an IC card, an IC tag, etc.

[Advantages of the Invention]

According to the present invention, although game chips are stacked, the game chips can be correctly recognized, and the data or information stored in the game chips can be successfully read.

Additional advantages and modifications will readily occur to those skilled in the art. Therefore, the invention in its broader aspects is not limited to the specific details or representative embodiments shown and described herein. Accordingly, various modification may be made without departing from the spirit or scope of the general inventive concept as defined by the appended claims and their equivalents.

What is claimed is:

1. A game chip storing data readable by a read device having an antenna which emits an electromagnetic wave, the game chip being available in a stack of other game chips, comprising:
a circuit for communicating data with the read device in response to a request from the read device;
an antenna being connected to the circuit, and being configured such that the antenna can enter a resonant state with the antenna of the read device through an electromagnetic wave; and
a reflector for reflecting an electromagnetic wave from the antenna of the read device toward upper game chips in the stack.

2. The game chip according to claim 1, wherein the game chip has a body member housing the circuit and the antenna, and the reflector is allocated at a peripheral portion of the body member.

3. The game chip according to claim 2, wherein the circuit is cylindrical, the antenna is a pair of electrodes between which the circuit is located, and the circuit and the reflector are arranged coaxially.

4. The game chip according to claim 3, wherein the reflector is a metallic foil or a plate made of at least one of iron, aluminum, and steel alloy.

5. The game chip according to claim 3, wherein the game chip further comprises a protection member which surrounds the reflector.

6. The game chip according to claim 5, wherein the reflector and the protection member are substantially the same in thickness.

7. The game chip according to claim 1, wherein the reflector is a cylindrical member arranged at a peripheral portion of the game chip, and when a plurality of game chips are stacked, reflectors of adjacent game chips contact each other.

8. The game chip according to claim 7, wherein the game chip has a body member housing the circuit and the antenna, and the reflector is allocated at a peripheral portion of the body member.

9. The game chip according to claim 8, wherein the circuit is cylindrical, the antenna is a pair of electrodes between which the circuit is located, and the circuit and the reflector are arranged coaxially.

10. The game chip according to of claim 8, wherein the reflector is a metallic foil or a plate made of at least one of iron, aluminum, and steel alloy.

11. The game chip according to claim 10, wherein the game chip further comprises a protection member which surrounds the reflector.

12. The game chip according to claim 11, wherein the reflector and the protection member are substantially the same in thickness.
